(19) United States
(12) Patent Application Publication
(10) Pub. No.: US 2010/0134521 A1
(43) Pub. Date: Jun. 3, 2010

(54) DEVICE COMPRISING A LIQUID CRYSTAL DISPLAY

(75) Inventors: Dirk Hente, Wuerselen (DE); Alexander Christiaan De Rijck, Waalre (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/063,239

(22) PCT Filed: Aug. 1, 2006
(86) PCT No.: PCT/IB06/52627

§ 371 Date: Feb. 8, 2008

(30) Foreign Application Priority Data
Aug. 9, 2005 (EP) 05107308.8

(51) Int. Cl. G09G 5/10

(52) U.S. Cl. 345/690; 345/102

(57) ABSTRACT

Devices (1) comprising liquid crystal displays (2) are given a reduced size by providing the liquid crystal displays (2) with liquid crystal display panels (21), with backlights for improving performances of the liquid crystal display panels (21), which backlights comprise organic light emitting diode backlights (23), and with backlight drivers (24) for driving segments of the organic light emitting diode backlights (23). This way diffusers can be avoided. The segmented organic light emitting diode backlights (23) are in the form of flat substrates and produce white light naturally. The backlight driver (24) may comprise scanning backlight drivers for driving the segments of the organic light emitting diode backlights (23) in a scanned way for reducing blur phenomena of the liquid crystal display panels (21) and/or may comprise individualizing backlight drivers for driving the segments of the organic light emitting diode backlights (23) or of ordinary backlights (26) in an individualized way for individualizing intensities of liquid crystal display panel segments.

The invention relates to a device comprising a liquid crystal display, and also relates to a liquid crystal display, to a backlight, to a backlight driver, to a method to drive the device.

Examples of such a device are televisions, monitors, vehicle equipment, craft equipment, plane equipment, laptop equipment such as personal computers and handheld equipment such as still picture cameras, motion video cameras and mobile phones.

A prior art liquid crystal display is known from US 2005/0007516 A1, which discloses for example in its paragraphs 0033 and 0034 a liquid crystal display panel, a light source or a light emitting diode array, and a diffuser. For improving a performance of the liquid crystal display panel, the light source can be turned on and off, and the light emitting diodes of the light emitting diode array can be turned on sequentially with a scanning direction of the liquid crystal display panel.

The prior art liquid crystal display is disadvantageous, inter alia, owing to the fact that it requires a diffuser for diffusing the light originating from the light source or from the light emitting diode array. The diffuser, that diffuses the light to have a large range of uniform distribution, increases a distance between the light source or the light emitting diode array on the one hand and the liquid crystal display panel on the other hand. This increases a size of the liquid crystal display.

It is an object of the invention, inter alia, to provide a device comprising a liquid crystal display that has a relatively small size.

Further objects of the invention are, inter alia, to provide a backlight, a backlight driver, a method, a computer program product and a medium for storing the computer program product for use in (combination with) a device comprising a liquid crystal display that has a relatively small size.

The liquid crystal display according to the invention comprises
a liquid crystal display panel,
a segmented organic light emitting diode backlight to illuminate the liquid crystal display panel, and
a backlight driver for driving the segments of the organic light emitting diode backlight.

By introducing a backlight comprising a segmented organic light emitting diode backlight and by introducing a backlight driver for driving the segments of the organic light emitting diode backlight, a diffuser is no longer necessary for diffusing the light originating from the organic light emitting diode backlight, owing to the fact that the light originating from the organic light emitting diode backlight already has a large range of uniform distribution. Further, the segmented organic light emitting diode backlight is in the form of a substrate, which makes it a very flat light source. This all decreases a size of the liquid crystal display.

The fact that the backlight driver can drive the segments of the organic light emitting diode backlight allows all segments to be driven in parallel as well as allows individual segments to be driven separately.

The liquid crystal display according to the invention is further advantageous, inter alia, in that its organic light emitting diode backlight produces white light naturally.

An embodiment of the liquid crystal display according to the invention is defined by the backlight driver comprising a scanning backlight driver for driving the segments of the organic light emitting diode backlight in a scanned way for reducing a blur phenomenon of the liquid crystal display panel. This embodiment for example comprises the driving of the segments of the organic light emitting diode backlight in a sequential way and/or in accordance with a scanning direction of the liquid crystal display panel. A segment of the organic light emitting diode backlight thereby for example corresponds with at least a part of one or more rows of the liquid crystal display panel and/or with at least a part of one or more columns of the liquid crystal display panel and may have, compared to a liquid crystal display panel segment, for example a similar size or a larger size.

An embodiment of the liquid crystal display according to the invention is defined by the backlight driver comprising an individualizing backlight driver for driving the segments of the organic light emitting diode backlight in an individualized way for individualizing intensities of liquid crystal display panel segments. This embodiment for example comprises the driving of the segments of the organic light emitting diode backlight in an individualized way such that a specific liquid crystal display panel segment is given a specific intensity by driving a corresponding segment of the organic light emitting diode backlight accordingly. As a result, the liquid crystal display panel is given an amended local contrast, such as an improved local contrast, for example based on information originating from a video signal to be displayed. A segment of the organic light emitting diode backlight thereby for example corresponds with at least a part of one or more rows of the liquid crystal display panel and/or with at least a part of one or more columns of the liquid crystal display panel and may have, compared to a liquid crystal display panel segment, for example a similar size or a larger size.

An embodiment of the liquid crystal display according to the invention is defined by the backlight driver comprising a scanning and individualizing backlight driver for driving the segments of the organic light emitting diode backlight in a scanned and individualized way for reducing a blur phenomenon of the liquid crystal display panel and for individualizing intensities of liquid crystal display panel segments. This embodiment for example combines, on the one hand, the driving of the segments of the organic light emitting diode backlight in a sequential way and/or in accordance with a scanning direction of the liquid crystal display panel and, on the other hand, the driving of the segments of the organic light emitting diode backlight in an individualized way such that a specific liquid crystal display panel segment is given a specific intensity by driving a corresponding segment of the organic light emitting diode backlight accordingly. As a result, the blur phenomenon of the liquid crystal display panel is reduced and the liquid crystal display panel is given an amended local contrast, such as an improved local contrast, for example based on information originating from a video signal to be displayed. In case of the liquid crystal display panel being driven line after line (for example row after row), the specific liquid crystal display panel segment comprises a line (for example a row). The corresponding segment of the organic light emitting diode backlight might then for example correspond with the corresponding line (for example the corresponding row) of the liquid crystal display panel and might then further for example comprise a previous line (for example a previous row) and a next line (for example a next row) of the organic light emitting diode backlight. This corresponds with driving the organic light emitting diode backlight one line ahead and three times as long compared to the driving of the liquid crystal display panel.

In other words, the latter embodiment defines that the driving of the liquid crystal display panel is overlapped by the driving of the organic light emitting diode backlight in time and place.

It should be noted that the embodiments wherein the backlight driver comprises an individualizing backlight driver and wherein the segments of the organic light emitting diode backlight are driven in an individualized way are not limited to the use of the organic light emitting diode backlight. These embodiments may alternatively be based on any other kind of backlight, such as for example a non-organic light emitting diode backlight.

An embodiment of the liquid crystal display according to the invention is defined by the organic light emitting diode backlight being an integral part of the liquid crystal display. This embodiment is most compact.

An embodiment of the liquid crystal display according to the invention is defined by the organic light emitting diode backlight being disconnectable from the liquid crystal display panel. This embodiment allows a replacement of the organic light emitting diode backlight.

It should further be noted that US 2003/0063231 discloses a liquid crystal display panel integrated with organic light emitting diodes. This document does not disclose (see paragraph 0014) that an organic light emitting diode backlight is to be used for improving a performance of the liquid crystal display panel, but discloses that each individual organic light emitting diode is always on and ready to emit the three primary colors. US 2005/0007517 discloses an organic light emitting diode backlight integrated liquid crystal display and does not disclose that its organic light emitting diode backlight is segmented and that a backlight driver is to be used for driving the different segments of the organic light emitting diode backlight. US 2004/0239839 discloses the driving of a liquid crystal display panel. U.S. Pat. No. 5,399,936 discloses an organic electroluminescent device.

Embodiments of the liquid crystal display according to the invention and of the backlight according to the invention and of the backlight driver according to the invention and of the method according to the invention and of the computer program product according to the invention and of the medium according to the invention correspond with the embodiments of the device according to the invention.

The invention is based on the insight, inter alia, that pointing light sources such as non-organic light emitting diodes require diffusers which increase a size of a liquid crystal display, and is based on the basic idea, inter alia, that organic light emitting diodes firstly emit light that already has a large range of uniform distribution and secondly are in the form of a substrate, which makes it a very flat light source. This all decreases a size of the liquid crystal display.

The invention solves the problem, inter alia, to provide a device comprising a liquid crystal display that has a relatively small size, and is further advantageous, inter alia, in that its organic light emitting diode backlight produces white light naturally.

These and other aspects of the invention will be apparent from and elucidated with reference to the embodiments(s) described hereinafter.

In the drawings:

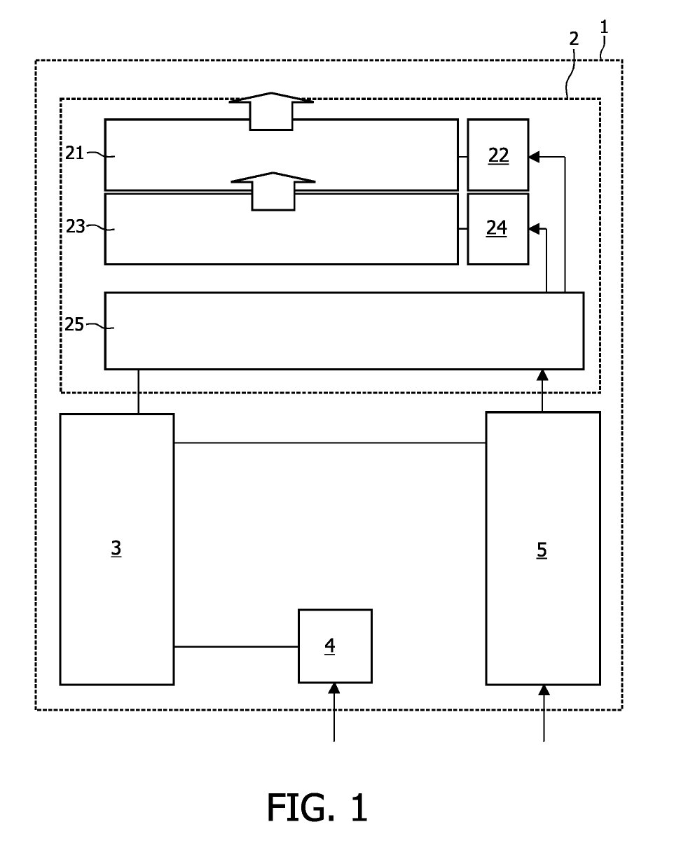

FIG. 1 shows diagrammatically a device according to the invention comprising a liquid crystal display according to the invention with an organic light emitting diode backlight according to the invention and a backlight driver according to the invention,

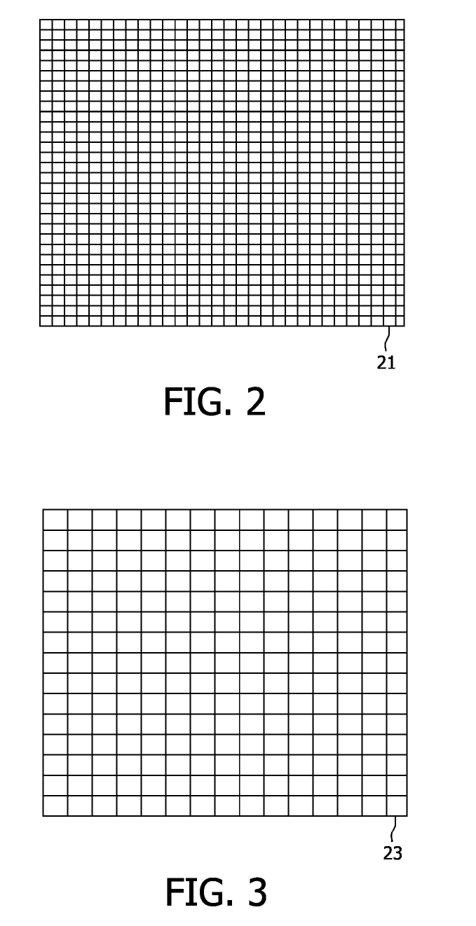

FIG. 2 shows diagrammatically a liquid crystal display panel,

FIG. 3 shows diagrammatically a segmented organic light emitting diode backlight according to the invention, and

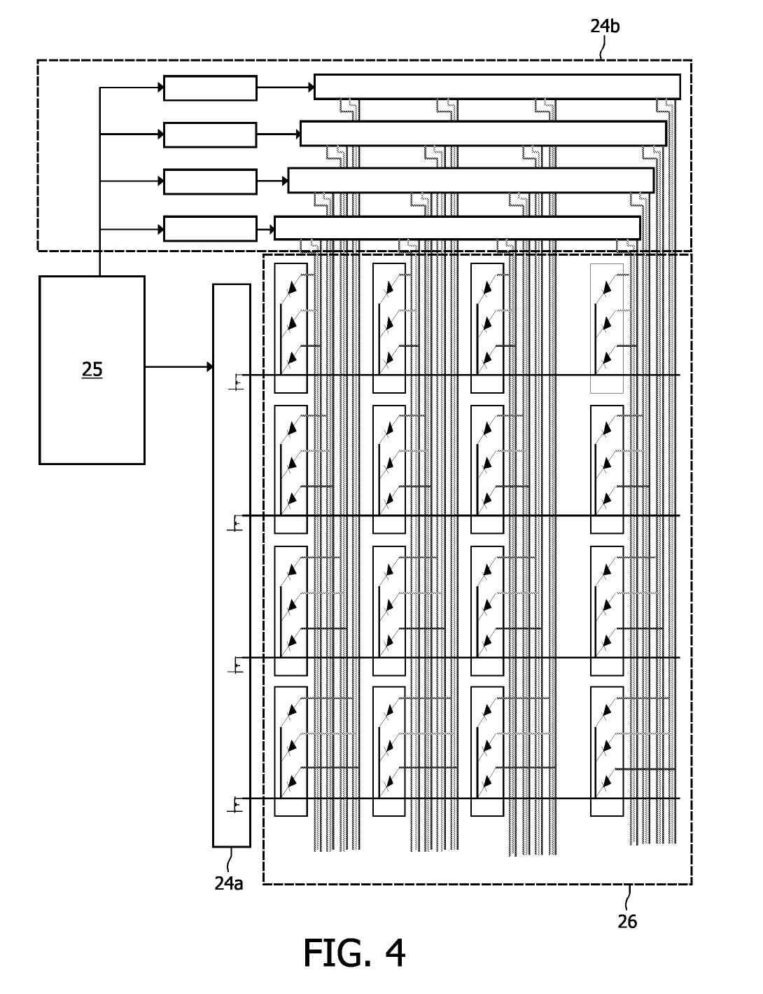

FIG. 4 shows diagrammatically a backlight driver according to the invention coupled to a backlight.

The device 1 according to the invention shown in FIG. 1 comprises a liquid crystal display 2 according to the invention. The liquid crystal display 2 comprises a prior art liquid crystal display panel 21 (side view), a backlight for improving a performance of the liquid crystal display panel 21, which backlight comprises a segmented organic light emitting diode backlight 23 according to the invention (side view), and a backlight driver 24 according to the invention for driving segments of the organic light emitting diode backlight 23. The liquid crystal display 2 further comprises a prior art liquid crystal display driver 22 and a controller 25 coupled to both drivers 22 and 24. Each one of the drivers 22 and 24 may for example comprise one or more row drivers and one or more column drivers. The device 1 further comprises a processor 3 coupled to an interface 4 and to a receiver 5. The interface 4 for example receives signals from a user and for example comprises an infrared receiver or a keyboard or a mouse. The receiver 5 receives a video signal to be displayed via the liquid crystal display panel 21 and is thereto further coupled to the controller 25.

The liquid crystal display panel 21 shown in FIG. 2 (in top view) for example comprises 30 rows and 30 columns, and the segmented organic light emitting diode backlight 23 shown in FIG. 3 (in top view) for example comprises 225 segments (15 segment rows and 15 segment columns).

The backlight driver 24 may comprise a scanning backlight driver for driving the segments of the organic light emitting diode backlight 23 in a scanned way for reducing a blur phenomenon of the liquid crystal display panel 21. The scanning backlight driver for example drives the segments of the organic light emitting diode backlight 23 in a sequential way and/or in accordance with a scanning direction of the liquid crystal display panel 21. A segment of the organic light emitting diode backlight 23 thereby for example corresponds with one cross point of one row and one column of the liquid crystal display panel 21 or with two or more cross points of the liquid crystal display panel 21. In FIGS. 2 and 3, in case the liquid crystal display panel 21 is driven row by row, the organic light emitting diode backlight 23 is driven segment row by segment row, in this case at half the speed or at double duration of the driving of the liquid crystal display panel 21, owing to the fact that the liquid crystal display panel 21 comprises twice as many rows and columns than there are segment rows and segment columns.

The backlight driver 24 according to the invention shown in FIG. 4 comprises a row driver 24a and four column drivers 24b. The four column drivers 24b comprise four column timers coupled to four column driver banks. The four column driver banks and the row driver 24a are further coupled to the backlight 26, and the four column timers and the row driver 24a are further coupled to the controller 25. The backlight 26 for example comprises prior art light emitting diodes as shown but may alternatively comprise a segmented organic light emitting diode backlight 23 according to the invention.

The backlight driver 24 may comprise an individualizing backlight driver for driving the segments of the backlight 26 in an individualized way for individualizing intensities of liquid crystal display panel segments. A liquid crystal display panel segment thereby for example corresponds with one cross point of one row and one column of the liquid crystal display panel 21 or with two or more cross points of the liquid crystal display panel 21. In FIGS. 2 and 3 (with FIG. 3 now being realized as shown in FIG. 4), a specific liquid crystal display panel segment may be given a specific intensity by driving a corresponding segment of the backlight 26 accordingly and a part of the liquid crystal display may be given an amended local contrast such as an improved local contrast by driving a number of corresponding segments of the backlight 26 accordingly. A segment of the backlight 26 thereby for example corresponds with one or more liquid crystal display panel segments. For example in case the liquid crystal display panel needs some more contrast in the left upper corner, some of the corresponding segments of the backlight 26 in the left upper corner are to be activated in case their corresponding liquid crystal display panel segments need more intensity and some others of the corresponding segments of the backlight 26 in the left upper corner are to be deactivated in case their corresponding liquid crystal display panel segments need less intensity.

The backlight driver 24 may comprise a scanning and individualizing backlight driver for driving the segments of the organic light emitting diode backlight 23 or the backlight 26 in a scanned and individualized way for reducing a blur phenomenon of the liquid crystal display panel 21 and for individualizing intensities of liquid crystal display panel segments. In case of the liquid crystal display panel 21 being driven line after line (for example row after row), the specific liquid crystal display panel segment may comprises a line (for example a row). The corresponding segment of the organic light emitting diode backlight 23 or the backlight 26 might then for example correspond with the corresponding line (for example the corresponding row) of the liquid crystal display panel 21 and might then further for example comprise a previous line (for example a previous row) and a next line (for example a next row) of the organic light emitting diode backlight 23 or the backlight 26. This corresponds with driving the organic light emitting diode backlight 23 or the backlight 26 one line ahead and three times as long compared to the driving of the liquid crystal display panel 21.

In other words, the latter embodiment defines that the driving of the liquid crystal display panel 21 is overlapped by the driving of the organic light emitting diode backlight 23 or the backlight 26 in time and place. In view of FIG. 4, this happens as follows.

In a background situation, most liquid crystal display backlights consist of fluorescent lamps. A new development is light emitting diode backlights. The light emitting diode backlights for liquid crystal display currently on the market just generate light just like the fluorescent lamp backlights and do not have a scanning feature. Scanning is desirable because it reduces motion artifacts. Another desirable feature is local highlighting or local dimming. In this case the backlight is modulated according to the video information on the liquid crystal display-display. The backlight burns brighter in lighter scenes and is dimmed in darker scenes. In this way a contrast improvement is reached.

When a scanning light emitting diode backlight is used, the motion artifacts will be greatly reduced but the light output will also be reduced, because the light emitting diodes will no longer be continuously on. To increase the light output of a scanning light emitting diode backlight, more lines are turned on simultaneously. Instead of a scanning line, a scanning band is used in the light emitting diode backlight. To do this, every light emitting diode column has multiple column drivers to ensure that each light emitting diode can still be addressed separately. In this way the advantages of scanning on the motion artifacts is maintained, local dimming of each and every light emitting diode is still ensured and the light output of the backlight will increase with respect to the same backlight without multi column drivers.

The light emitting diode backlight consists of a matrix with rows and columns as shown in FIG. 4. Each crossing of a row and a column has a light emitting diode connected. In this case, red-green-blue light emitting diodes are used, but white or any other color light emitting diodes can also be used. The example here is implemented with four column driver banks with four column drivers per light emitting diode column, but is valid for any number of column drivers. The first column driver bank is connected to the light emitting diodes on row 1, 5, 9, etc. The second column driver bank is connected to the light emitting diodes on row 2, 6, 10, etc. The third column driver bank is connected to the light emitting diodes on row 3, 7, 11, etc. The fourth column driver bank is connected to the light emitting diodes on row 4, 8, 12, etc. Each separate column driver bank has per column a separate column timer with which each individual column can be driven with a pulse width modulation signal to ensure that each individual light emitting diode in the matrix can have its own driver signal and thus its own brightness.

The driving sequence is for example as follows:

Row 1 is turned on for the first line time and remains on for four line times.
Row 2 is turned on for the second line time and remains on for four line times.
Row 3 is turned on for the third line time and remains on for four line times.
Row 4 is turned on for the fourth line time and remains on for four line times.
Row 5 is turned on for the fifth line time after row 1 is switched off and remains on for four line times.
Row 6 is turned on for the sixth line time after row 2 is switched off and remains on for four line times.
Row 7 is turned on for the seventh line time after row 3 is switched off and remains on for four line times.
Row 8 is turned on for the eighth line time after row 4 is switched off and remains on for four line times, etc.

When a row is active the brightness of the light emitting diodes on that row is controlled by the respective column drivers by means of a pulse width modulation signal. The pulse width modulation signal must correspond to the brightness that is to be reached in four line times. The example is given for four column drivers per light emitting diode column but can be scaled to any number. The number of column drivers per light emitting diode column scales linearly with the number of rows that must be on simultaneously.

The organic light emitting diode backlight 23 may be an integral part of the liquid crystal display 2 or may be disconnectable from the liquid crystal display 2. Each segment may be a real segment or may be an imaginary segment. The processor 3 may comprise or may be coupled to a medium not shown for storing a computer program product to be run via the processor 3, which computer program product comprises the functions of improving a performance of a liquid crystal display panel 21 via a backlight comprising an organic light emitting diode backlight 23, and driving segments of the organic light emitting diode backlight 23 via a backlight driver 24.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1-9. (canceled)

10. A liquid crystal display (2) comprising
a liquid crystal display panel (21),
a segmented organic light emitting diode backlight (23) for producing white light naturally to illuminate the liquid crystal display panel (21), and
a backlight driver (24) for driving the segments of the organic light emitting diode backlight (23).

11. The liquid crystal display (2) as defined in claim 10, the backlight driver (24) comprising an individualizing backlight driver for driving the segments of the organic light emitting diode backlight (23) in an individualized way for individualizing an intensity of a liquid crystal display panel segment.

12. The liquid crystal display (2) as defined in claim 11, the liquid crystal display (2) being arranged to give the liquid crystal display panel segment an amended contrast based on information originating from a video signal to be displayed.

13. The liquid crystal display (2) as defined in claim 10, the backlight driver (24) comprising a scanning backlight driver for driving the segments of the organic light emitting diode backlight (23) in a scanned way for reducing a blur phenomenon of the liquid crystal display panel (21).

14. The liquid crystal display (2) as defined in claim 10, the organic light emitting diode backlight (23) being an integral part of the liquid crystal display (2).

15. The liquid crystal display (2) as defined in claim 10, the organic light emitting diode backlight (23) being disconnectable from the liquid crystal display panel (21).

16. A segmented organic light emitting diode backlight (23) as defined in claim 10.

17. A device (1) comprising a liquid crystal display (2) as defined in claim 10.

18. A method for operating a liquid crystal display (2) comprising a liquid crystal display panel (21), the method comprising the steps of
illuminating the liquid crystal display panel (21) via a segmented organic light emitting diode backlight (23) that produces white light naturally, and
driving the segments of the organic light emitting diode backlight (23).

19. The method as defined in claim 18, further comprising the step of
driving the segments of the organic light emitting diode backlight (23) in an individualized way for individualizing an intensity of a liquid crystal display panel segment to give the liquid crystal display panel segment an amended contrast based on information originating from a video signal to be displayed.
